(19) United States
(12) Patent Application Publication
(10) Pub. No.: US 2005/0194234 A1
(43) Pub. Date: Sep. 8, 2005

(54) Conveying apparatus and method of conveying a workpiece

(75) Inventors: Andreas Schmohl, Frickenhausen (DE); Thomas Heinemeier, Macomb, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Duerr Automotion GmbH, Stuttgart (DE)

(21) Appl. No.: 11/061,362

(22) Filed: Feb. 18, 2005

Related U.S. Application Data
(63) Continuation of application No. PCT/EP03/06872, filed on Jun. 28, 2003.

(30) Foreign Application Priority Data
Aug. 22, 2002 (DE) 102 38 493.2

(51) Int. Cl. B65G 43/00

(52) U.S. Cl. 198/346.2

(57) ABSTRACT

In order to provide a conveying apparatus for conveying a workpiece, in particular a vehicle body disposed on a workpiece support, from a first position on a first conveying level to a second position on a second conveying level, comprising a conveying carriage, which is movable from a first location associated with the first position of the workpiece to a second location associated with the second position of the workpiece and from the second location to the first location, which apparatus needs a comparatively short cycle time for the operation of conveying a workpiece from the first conveying level to the second conveying level, it is proposed that the conveying carriage comprises a retaining device having at least one retaining element, which is movable relative to the conveying carriage from an operating position, in which the retaining element may act on the workpiece support, into an inoperative position, in which the retaining element is movable past the workpiece support, and from the inoperative position into the operating position.

This application is a continuation application of PCT/EP2003/006872 filed Jun. 28, 2003, the entire specification of which is incorporated herein by reference.

The present invention relates to a conveying apparatus for conveying a workpiece, in particular a vehicle body, disposed on a workpiece-support, from a first position on a first conveying level to a second position on a second conveying level, wherein the conveying apparatus comprises a conveying carriage, which is movable from a first location associated with the first position of the workpiece to a second location associated with the second position of the workpiece and from the second location to the first location.

Such conveying apparatuses are known from the background art.

In particular, lifting devices for lifting a vehicle body disposed on a skid frame from a first conveying level to a higher second conveying level are known, which comprise a roller conveyor liftable and lowerable in vertical direction, onto which the vehicle body is conveyed on the first conveying level by a roller conveyor disposed upstream of the conveying apparatus and from which the vehicle body is conveyed on the second conveying level onto a roller conveyor disposed downstream of the conveying apparatus.

For loading this vertically movable roller conveyor on the first conveying level, lifting the roller conveyor to the second conveying level, unloading the roller conveyor on the second conveying level and completing the conveying cycle by lowering the movable roller conveyor to the first conveying level a relatively long cycle time is required.

The underlying object of the present invention is therefore to provide a conveying apparatus of the initially described type, which for the operation of conveying a workpiece from the first conveying level to the second conveying level requires a relatively short cycle time.

In a conveying apparatus having the features of the preamble of claim 1, this object is achieved according to the invention in that the conveying carriage comprises a retaining device having at least one retaining element, which is movable relative to the conveying carriage from an operating position, in which the retaining element may act on the workpiece support, into an inoperative position, in which the retaining element is movable past the workpiece support, and from the inoperative position into the operating position.

The second conveying level may be higher or lower than the first conveying level.

Furthermore, it may also be provided that a plurality of second conveying levels at different heights are provided, to which the workpiece may be selectively conveyed.

The concept according to the invention allows the conveying carriage with the retaining device to move past a workpiece already waiting in the first position and then to accept the already waiting workpiece onto the conveying carriage by transferring the retaining element from the inoperative position to the operating position. The workpiece may therefore already have been moved into the first position while the conveying carriage is still situated outside of its first location associated with the first position of the workpiece. As a result, the cycle time needed for a workpiece conveying operation is considerably reduced.

In contrast to the solution according to the invention, with the previously described, already known lifting device having a vertically movable roller conveyor the roller conveyor always has to be moved back into its initial location on the first conveying level before the next vehicle body may be moved onto this vertically movable roller conveyor. With this previously known lifting device it is therefore not possible to bring a vehicle body into the first position on the first conveying level while the vertically movable roller conveyor is situated outside of its first location associated with the first position of the vehicle body.

For the nature of the movement of the retaining element from the operating position into the inoperative position, any desired, simple or complex movement is conceivable.

In a preferred development of the invention, however, it is provided that the retaining element is pivotable from the operating position into the inoperative position.

It is preferably provided that the retaining element is pivotable about a substantially horizontal swivelling axis.

In principle, it would be conceivable to move the retaining element of the retaining device from the operating position into the inoperative position and/or from the inoperative position into the operating position by means of actuating elements that are not moved simultaneously with the conveying carriage. For example, it would be conceivable to provide on the retaining element a gear wheel that interacts with a stationary toothed rack in such a way that the retaining element is moved at the desired point from the operating position into the inoperative position and/or from the inoperative position into the operating position.

A particularly easy controllability of the movement of the retaining element from the operating position into the inoperative position and from the inoperative position into the operating position is however enabled when the retaining element is movable from the operating position into the inoperative position and/or from the inoperative position into the operating position by means of a motor, which is disposed on the conveying carriage, in particular on the retaining device.

In a preferred development of the conveying apparatus according to the invention, it is provided that the retaining device comprises at least two retaining elements, which are mutually spaced apart in a longitudinal direction of the retaining device.

In order to be able to move the retaining device past the workpiece support without difficulty, it is advantageously provided that the spacing of the two retaining elements along the longitudinal direction of the retaining device in the inoperative position of the retaining elements is larger than the extent of the workpiece support in the longitudinal direction of the retaining device.

It is moreover preferably provided that the retaining device comprises at least two retaining elements, which are mutually spaced apart transversely of a longitudinal direction of the retaining device.

Such a development of the retaining device is particularly advantageous when the workpiece is disposed on a skid frame.

Here, by skid frame in the present description and the accompanying claims is meant any workpiece support that comprises at least two skid runners extending parallel to the conveying direction and mutually spaced apart at right angles to the conveying direction. In said case, the skid runners may be connected to one another either by cross struts or by the workpiece itself.

When the workpiece to be conveyed is disposed on a skid frame, it is particularly advantageous when the two retaining elements, which are mutually spaced apart transversely of a longitudinal direction of the retaining device, are mutually offset transversely of a longitudinal direction of the retaining device by substantially the same distance, by which the skid runners of the skid frame are mutually offset transversely of the longitudinal direction of the retaining device. The effect thereby achieved is that each skid runner of the skid frame is supported by in each case one of the two retaining elements.

The retaining element may, in principle, act in any desired way on the workpiece support.

It would, for example, be conceivable for the retaining element to comprise a clamping device for firmly clamping the workpiece support to the retaining device.

In a development of the conveying apparatus according to the invention that is particularly easy to manufacture, it is however provided that the retaining element comprises a carrying plate for carrying a region of the workpiece support.

It is therefore sufficient for the workpiece support to be supported in a downward direction by means of the retaining element of the retaining device. A fixing of the workpiece support to the retaining element is not necessary.

In order that the workpiece may already be conveyed into the first position before the conveying carriage returns to its first location, it is advantageously provided that the conveying apparatus comprises an acceptance platform, by which the workpiece in the first position is accepted from the retaining device of the conveying carriage.

This acceptance platform may be disposed, for example, in a stationary manner.

Alternatively thereto, it may however be provided that the acceptance platform is movable relative to the first position of the workpiece. Such a development is particularly advantageous when the first conveying level is higher than the second conveying level, to which the workpiece is to be conveyed.

In particular, it may be provided that the acceptance platform is movable, in particular displaceable, transversely of a conveying direction, along which the workpiece is conveyed on the first conveying level to the conveying apparatus.

The movement of the acceptance platform may be effected, for example, by means of a telescopic drive.

In a particularly preferred development of the conveying apparatus according to the invention, it is provided that the acceptance platform takes the form of a roller conveyor.

When the retaining device of the conveying apparatus comprises two retaining elements that are mutually spaced apart along a longitudinal direction of the retaining device, it is particularly advantageous when the extent of the acceptance platform along the longitudinal direction of the retaining device is smaller than the spacing of the two retaining elements along the longitudinal direction of the retaining device in the inoperative position and/or in the operating position of the retaining elements.

When the extent of the acceptance platform along the longitudinal direction of the retaining device is smaller than the spacing of the two retaining elements in the inoperative position of the retaining elements, the effect thereby achieved is that the retaining device with the retaining elements situated in the inoperative position may be moved past the acceptance platform.

When the extent5 of the acceptance platform along the longitudinal direction of the retaining device is smaller than the spacing of the two retaining elements in the operating position of the retaining elements, the effect thereby achieved is that the retaining elements in a position of the retaining device, in which the retaining elements are situated at the same height as the acceptance platform, may be moved from the inoperative position into the operating position and that the retaining elements in the operating position may be moved past the acceptance platform in order to lift the workpiece from the first position off the acceptance platform.

In order to be able to remove the workpiece in the second position as rapidly as possible from the conveying carriage and hence be able to move the conveying carriage as rapidly as possible back into the first location, it is advantageous when the conveying apparatus comprises a transfer platform, to which the workpiece in the second position may be transferred by the retaining device of the conveying carriage.

This transfer platform may be disposed in a stationary manner.

Particularly when the second conveying level is situated higher than the first conveying level, it is however advantageous when the transfer platform is movable relative to the second position of the workpiece.

In particular, it may be provided that the transfer platform is movable, in particular displaceable, transversely of a conveying direction, along which the workpiece is conveyed further on the second conveying level.

The movement of the transfer platform may be effected, for example, by means of a telescopic drive.

In a particularly preferred development of the conveying apparatus according to the invention, it is provided that the transfer platform takes the form of a roller conveyor.

When the retaining device of the conveying carriage comprises two retaining elements that are mutually spaced apart along a longitudinal direction of the retaining device, it is preferably provided that the extent of the transfer platform along the longitudinal direction of the retaining device is smaller than the spacing of the two retaining elements along the longitudinal direction of the retaining device in the inoperative position and/or in the operating position of the retaining elements.

When the extent of the transfer platform along the longitudinal direction of the retaining device is smaller than the spacing of the two retaining elements in the inoperative position, the effect thereby achieved is that the retaining device with the retaining elements situated in the inoperative position may be moved past the transfer platform.

When the extent of the transfer platform along the longitudinal direction of the retaining device is smaller than the spacing of the two retaining elements in the operating position of the retaining elements, the effect thereby achieved is that the retaining elements in a position of the retaining device, in which the retaining elements are disposed at the same height as the transfer platform, may be moved from the inoperative position to the operating position. In this case, it is moreover possible for the retaining elements situated in the operating position to be moved past the transfer platform.

In order to achieve as short a cycle time as possible for the operation of conveying a workpiece from the first conveying level to the second conveying level, it is advantageous when the workpiece is bringable into the first position while the conveying carriage is situated outside of the first location. In this way, it is possible to utilize the time, during which the conveying carriage is situated outside of the first location, to transport a workpiece into the first position.

Furthermore, in order to reduce the cycle time needed to convey the workpieces from the first conveying level to the second conveying level, it is advantageous when a workpiece is bringable into the first position while another workpiece is still retained at the retaining device of the conveying carriage. In this way, the time taken to transport a workpiece from the first position to the second position may already be used to transport the next workpiece into the first position.

Claim 26 is directed to a conveying system, which comprises a conveying apparatus according to the invention and at least one conveying device, which feeds the workpiece to the conveying apparatus on the first conveying level.

In a preferred development of such a conveying system, it is provided that the conveying device that feeds the workpiece to the conveying apparatus comprises at least one roller conveyor.

Claim 28 is directed to a conveying system, which comprises a conveying apparatus according to the invention and at least one conveying device, which accepts the workpiece from the conveying apparatus on the second level.

In a particularly preferred development of such a conveying system, it is provided that the conveying device that accepts the workpiece from the conveying apparatus on the second conveying level comprises at least one roller conveyor.

The present invention further relates to a method of conveying a workpiece, in particular a vehicle body disposed on a workpiece support, from a first position on a first conveying level to a second position on a second conveying level by means of a conveying carriage, which is moved from a first location associated with the first position of the workpiece into a second location associated with the second position of the workpiece and from the second location into the first location.

A further underlying object of the present invention is to provide such a method, whereby which the cycle time needed to convey a workpiece from the first conveying level to the second conveying level is comparatively short.

In a method having the features of the preamble of claim 30, this object is achieved according to the invention in that at least one retaining element of a retaining device of the conveying carriage is moved relative to the conveying carriage from an operating position into an inoperative position, is moved in the inoperative position past the workpiece support, then is moved from the inoperative position into the operating position, and in the operating position acts on the workpiece support.

The method according to the invention offers the advantage that the retaining device of the conveying carriage may be moved past a workpiece already waiting in the first position, so that the next workpiece may already be brought into the first position while the conveying carriage is situated outside of the first location and is transporting the preceding workpiece from the first position into the second position. This markedly reduces the necessary cycle time.

Special developments of the method according to the invention are the subject matter of the dependent claims 31 to 43, the advantages of which have already been explained above in connection with special developments of the conveying apparatus according to the invention.

Further features and advantages of the invention are the subject matter of the following description and the graphic representation of an embodiment.

The drawings show:

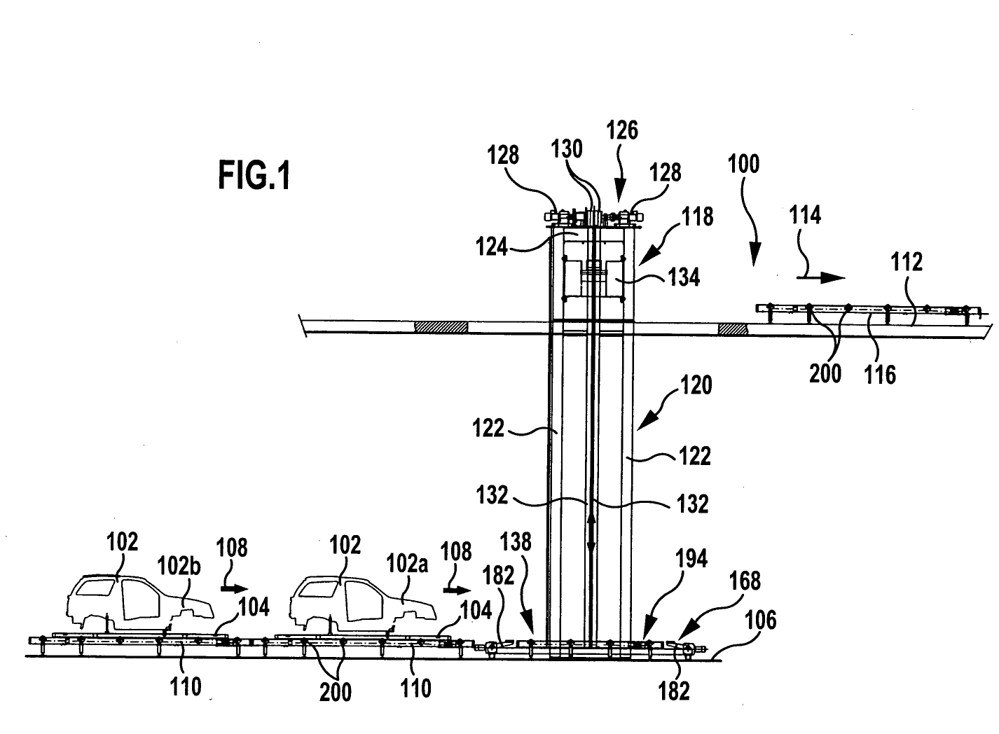

FIG. 1 a diagrammatic side view of a conveying apparatus for conveying vehicle bodies from a lower first conveying level to an upper second conveying level, wherein vehicle bodies to be conveyed are situated on roller conveyors disposed upstream of the conveying apparatus;

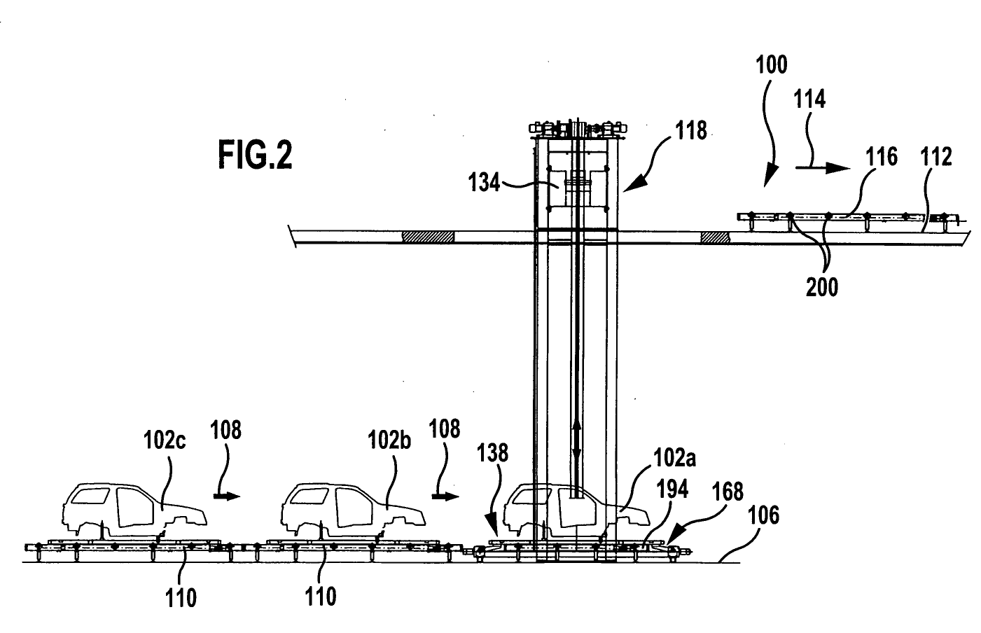

FIG. 2 a view corresponding to FIG. 1 in a later phase, in which a vehicle body to be conveyed is situated on a stationary roller conveyor of the conveying apparatus;

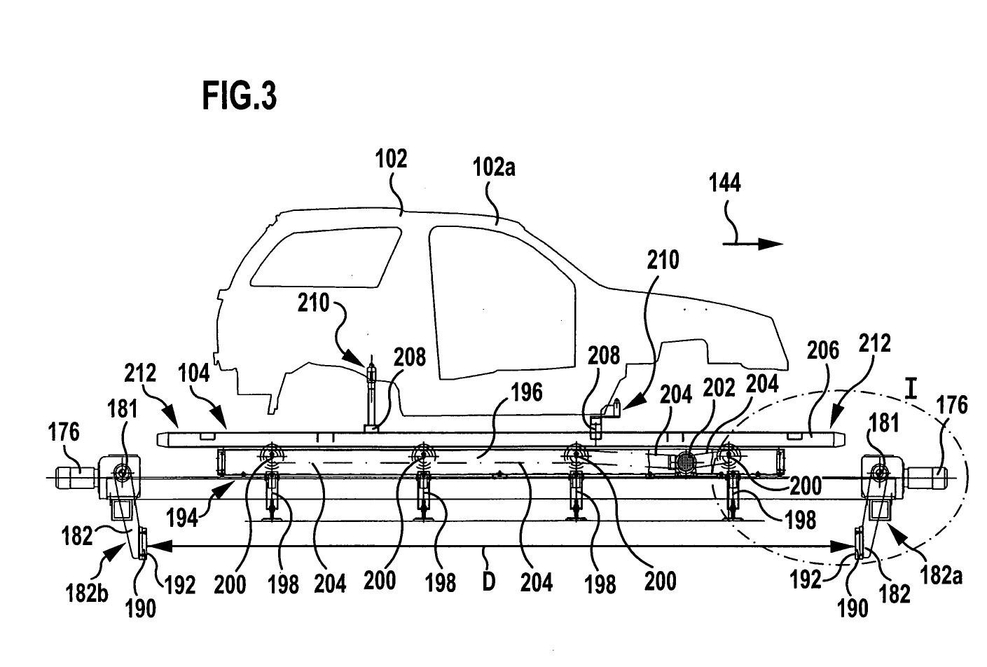

FIG. 3 an enlarged view of the vehicle body situated on the stationary roller conveyor and of a retaining device of a conveying carriage of the conveying apparatus, with retaining elements situated in an inoperative position;

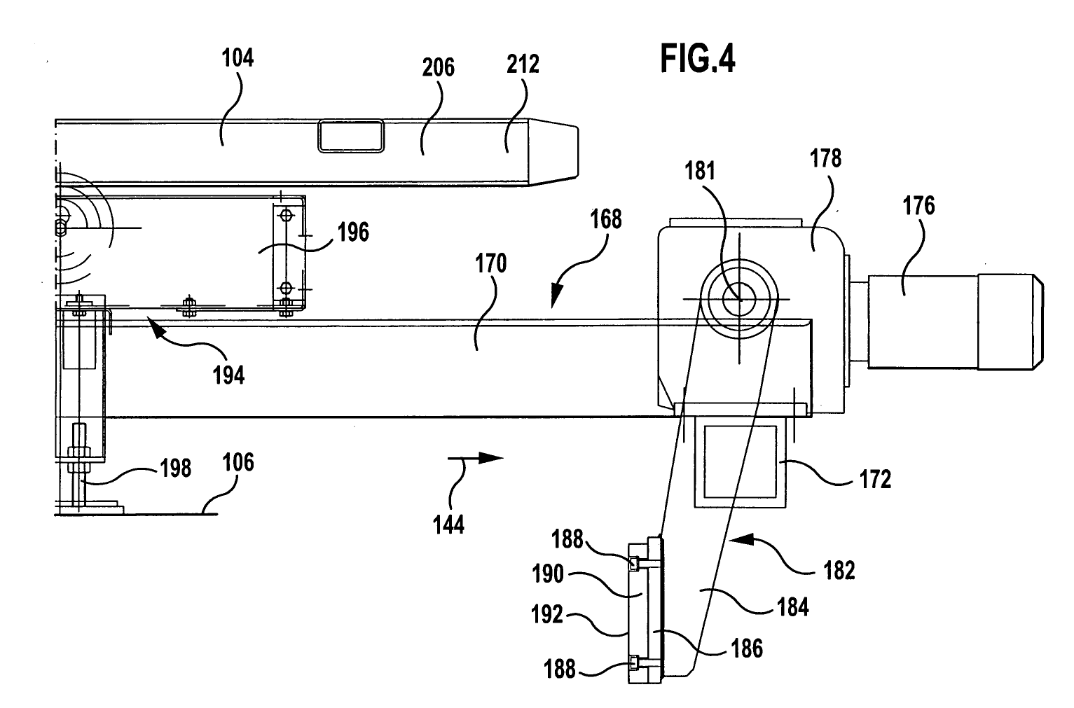

FIG. 4 an enlarged view of the region I of FIG. 3;

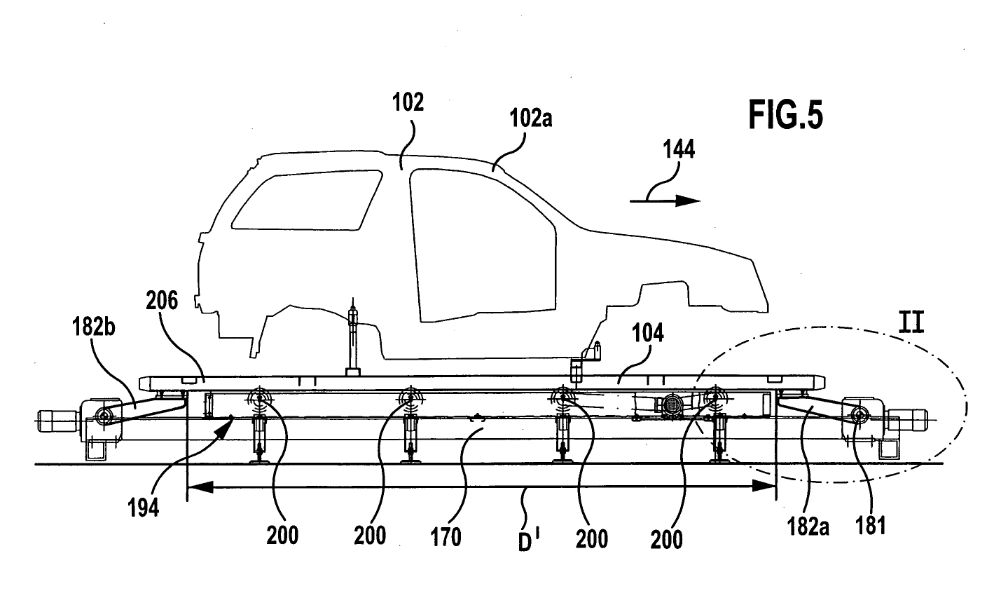

FIG. 5 a view corresponding to FIG. 3 of the vehicle body disposed on the stationary roller conveyor, wherein the retaining elements are situated in an operating position, in which front and back ends of the skid runners of a skid frame, on which the vehicle body is disposed, are carried by carrying plates of the retaining elements;

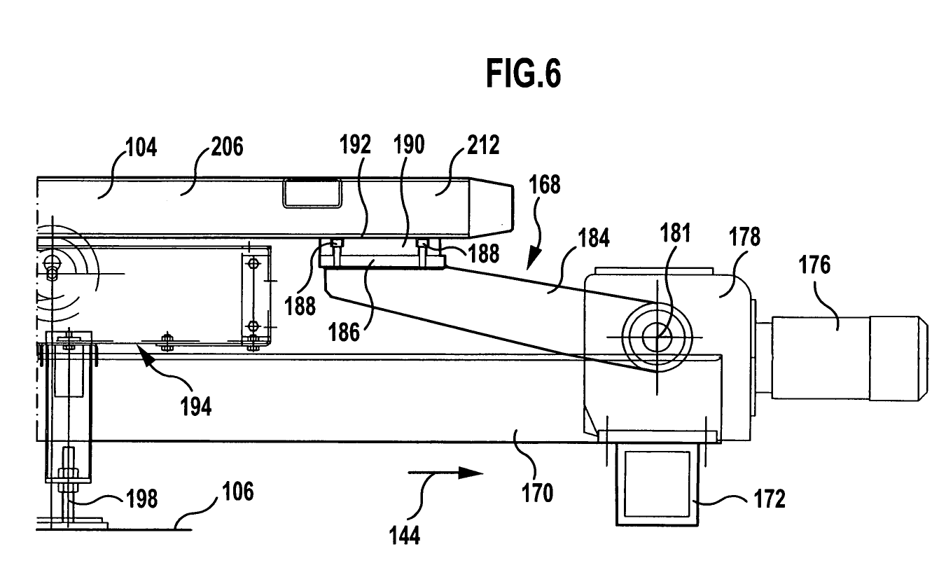

FIG. 6 an enlarged view of the region II of FIG. 5;

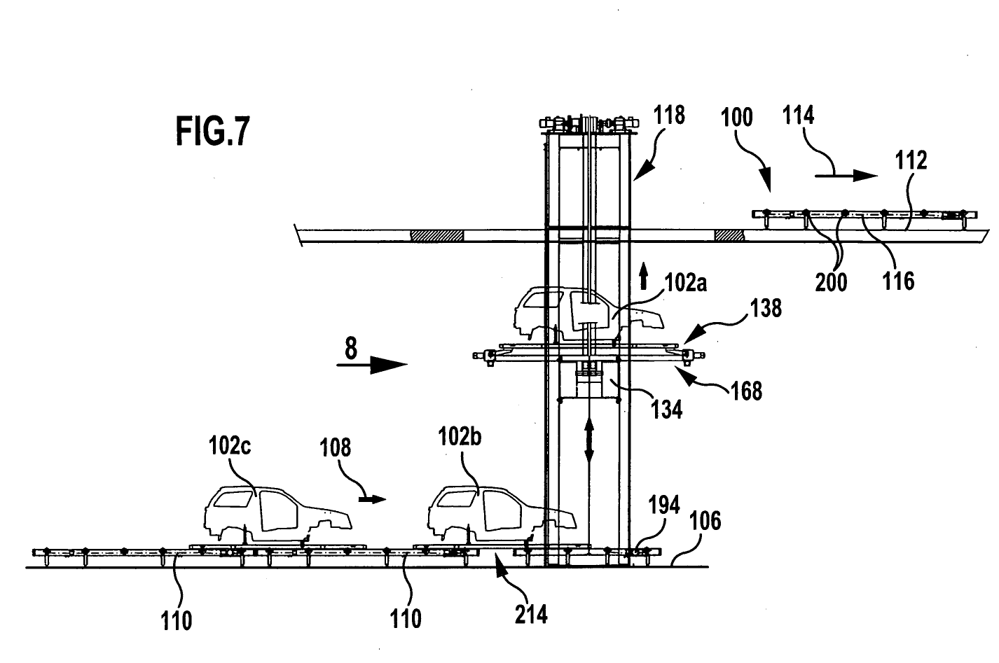

FIG. 7 a diagrammatic side view of the conveying apparatus in a phase, in which a vehicle body is conveyed by means of the conveying carriage from the first conveying level to the second conveying level and, at the same time, a further vehicle body is conveyed onto the stationary roller conveyor of the conveying apparatus;

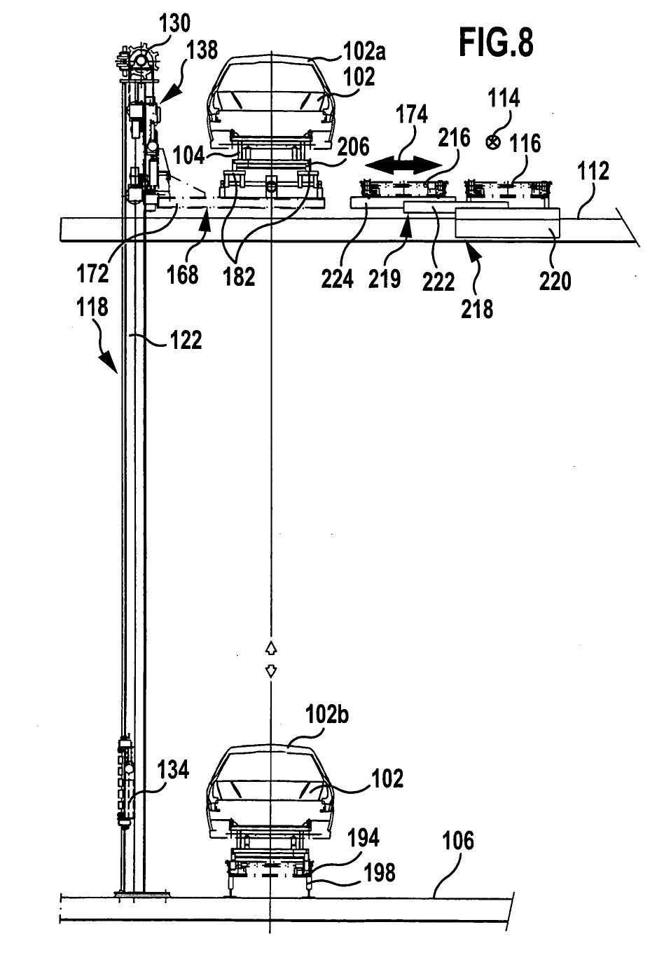

FIG. 8 a diagrammatic front view of the conveying apparatus, viewed in the direction of the arrow 8 in FIG. 7, in a phase, in which the conveying carriage has conveyed the first vehicle body into a position on the upper second conveying level and a movable roller conveyor of the conveying apparatus is moved under the first vehicle body by means of a telescopic unit, while the second vehicle body is situated on the stationary roller conveyor on the lower first conveying level;

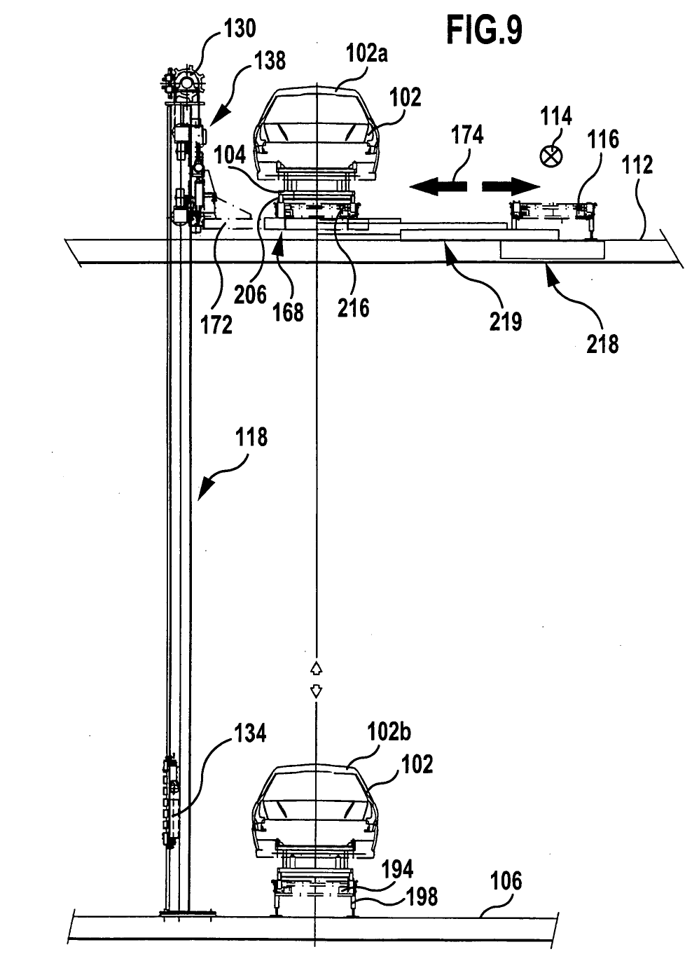

FIG. 9 a view corresponding to FIG. 8 in a later phase, in which the movable roller conveyor has reached its location under the first vehicle body;

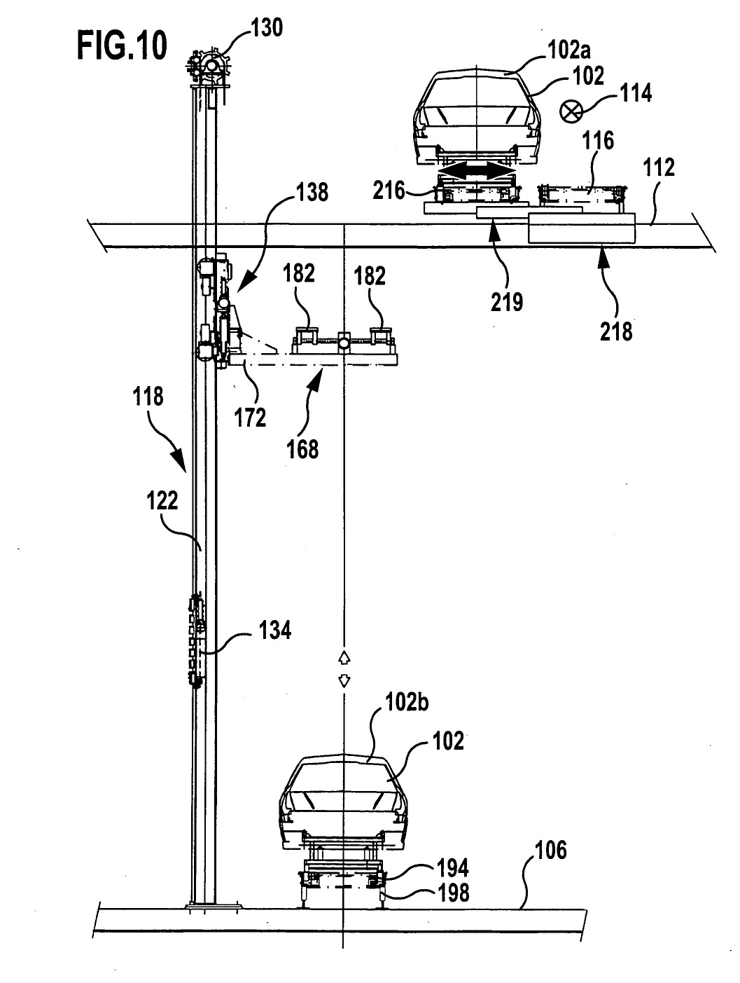

FIG. 10 a view corresponding to FIG. 9 in a later phase, in which the first vehicle body has been transferred from the conveying carriage to the movable roller conveyor and the movable roller conveyor is moved by means of the telescopic unit back into its original location, in which it is aligned with further roller conveyors disposed on the upper second conveying level, while the conveying carriage moves back to the first conveying level;

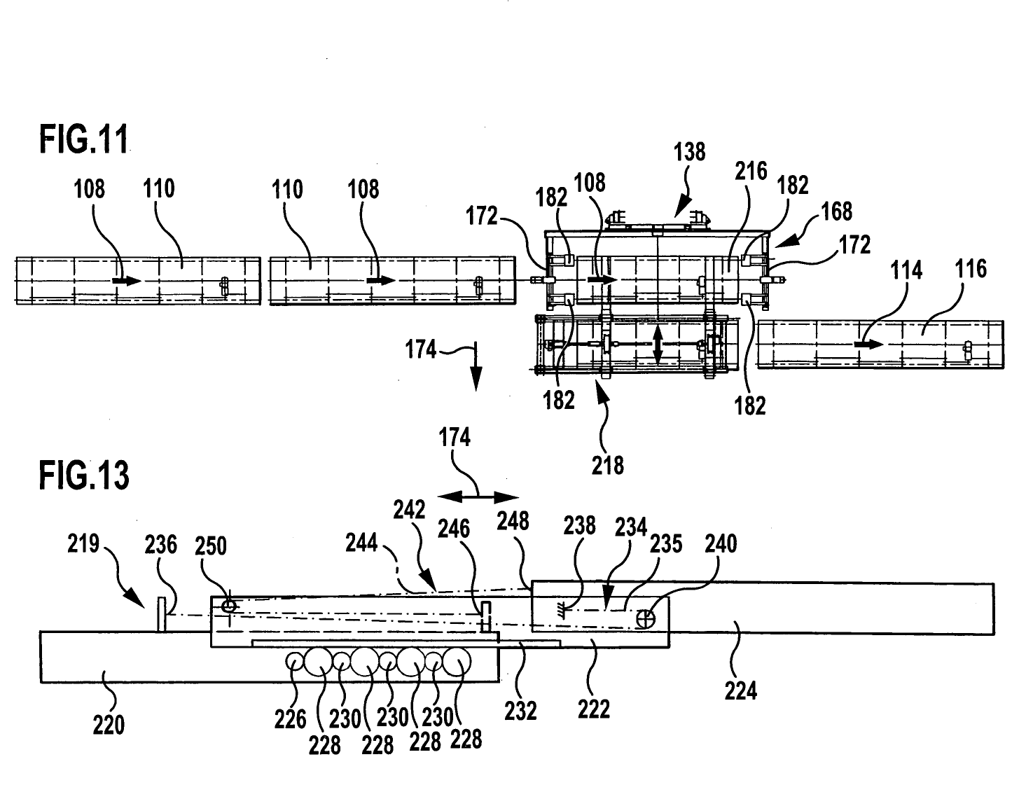

FIG. 11 a plan view of the conveying apparatus, wherein the movable roller conveyor has been moved between the retaining elements of the retaining device of the conveying carriage by means of the telescopic unit;

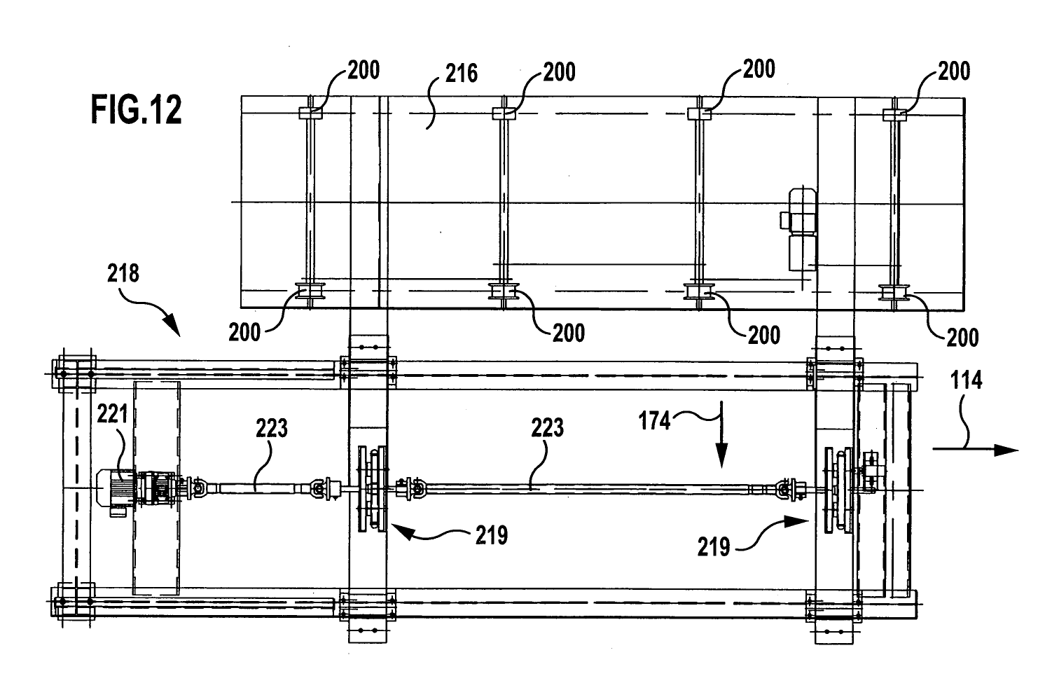

FIG. 12 an enlarged view of the movable roller conveyor and the telescopic unit of FIG. 11;

FIG. 13 a diagrammatic side view of the telescopic unit, by means of which the movable roller conveyor is moved;

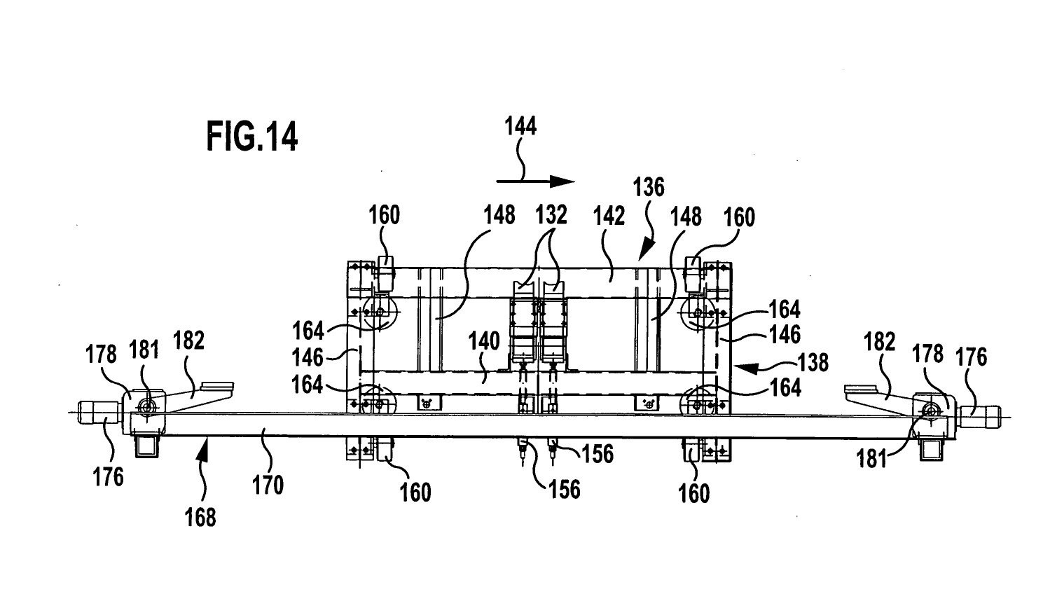

FIG. 14 a diagrammatic side view of the conveying carriage of the conveying device with the retaining device disposed thereon;

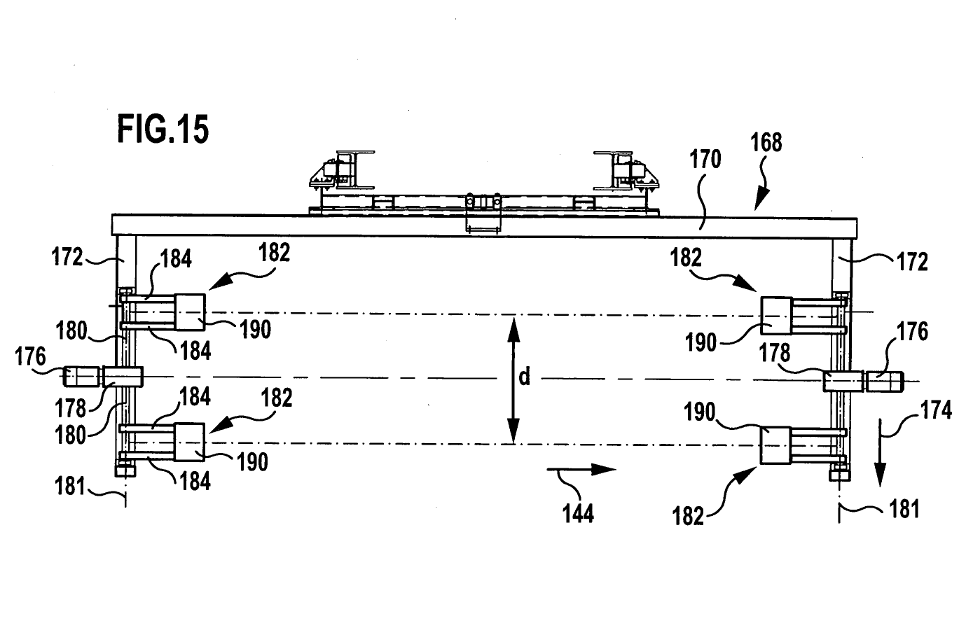

FIG. 15 a diagrammatic plan view of the conveying carriage with the retaining device of FIG. 14;

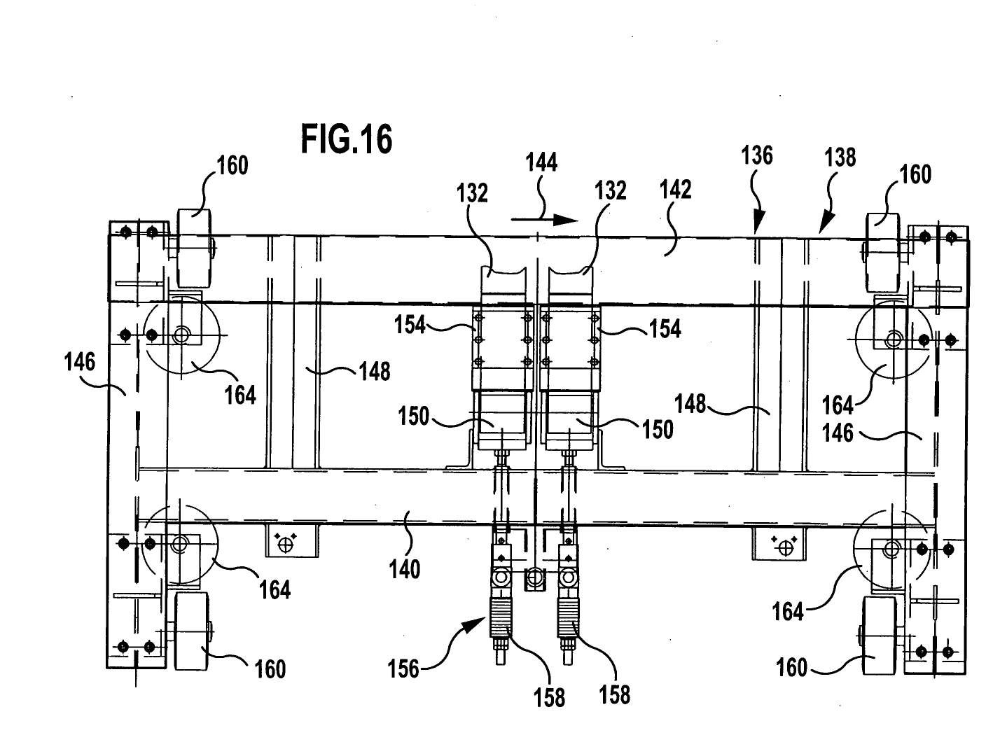

FIG. 16 a diagrammatic side view of the conveying carriage without the retaining device disposed thereon;

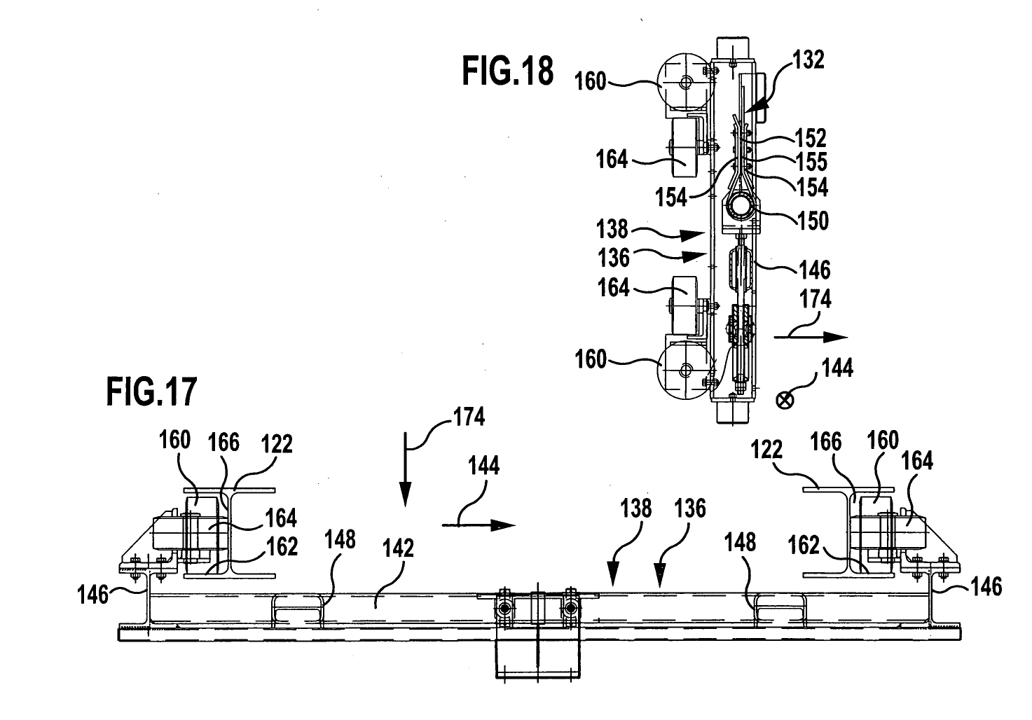

FIG. 17 a diagrammatic plan view of the conveying carriage without the retaining device; and

FIG. 18 a diagrammatic front view of the conveying carriage without the retaining device disposed thereon.

In all of the drawings, identical or functionally equivalent elements are denoted by the same reference characters.

In FIGS. 1 to 18 a conveying system denoted as a whole by 100 for conveying vehicle bodies 102 disposed on skid frames 104 is illustrated, which comprises a plurality of roller conveyors 110 disposed successively along a first conveying direction 108 on a first conveying level 106, a plurality of roller conveyers 116 disposed successively along a second conveying direction 114 on a second conveying level 112 that is higher than the first conveying level 106, as well as a conveying apparatus denoted as a whole by 118 for conveying the vehicle bodies 102 disposed on the skid frames 104 from the first conveying level 106 to the second conveying level 112.

The conveying apparatus 118 comprises a framework 120, which in turn comprises two vertical posts 122 mutually spaced apart along the first conveying direction 108, which comprise e.g. an H-section (see FIG. 17) and are connected to one another at their upper ends by a crossbeam 124.

The crossbeam 124 carries a drive unit 126 having rotary drive motors 128, which set two driving rollers 130 in rotation about a horizontal axis of rotation, which extends parallel to the first conveying direction 108.

Looped around each of the driving rollers 130 there is in each case a carrying belt 132, which is fastened at a trailing end to a counterweight 134 and at a leading end to a guide framework 136 of a conveying carriage 138.

By a rotational movement of the driving rollers 130 the conveying carriage 138 guided on the posts 122 may be lifted and, at the same time, the counterweight 134 may be correspondingly lowered, wherein transmission of the lifting force to the conveying carriage 138 is effected by means of the friction-locking connection between the carrying belts 132 and the driving rollers 130.

By reversing the direction of rotation of the driving rollers 130, the conveying carriage 138 may accordingly be lowered while, at the same time, the counterweight 134 is lifted.

The guide framework 136 of the conveying carriage 138 (see FIGS. 16 to 18) comprises a bottom longitudinal strut 140 and a top longitudinal strut 142, which extend parallel to one another along a horizontal longitudinal direction 144 of the conveying carriage 138 and are connected to one another at their ends by means of outer vertical struts 146 and between their end regions by means of inner vertical struts 148.

Fastened to the upper side of the bottom longitudinal strut 140 are two retaining tubes 150, the centre lines of which are aligned parallel to the longitudinal direction 144 and around which the leading ends of the carrying belts 132 are wrapped. The free end 152 of each carrying belt 132 is braced by means of, in each case, two retaining plates 154 with a portion 155 of the respective carrying belt 132 that is situated in front of the retaining tube 150.

Disposed on the underside of the bottom longitudinal strut 140 is a height-equalizing device 156, which is used for elastic height adaptation of the retaining tubes 150 and may comprise e.g. two stacks of cup springs 158.

Disposed on the top and bottom ends of the outer vertical struts 146 of the guide framework 136 there is in each case a transverse guide roller 160, which is rotatable about an axis of rotation extending parallel to the longitudinal direction 144. As the conveying carriage 138 moves up and down, these transverse guide rollers 160 roll along transverse guide surfaces 162 of the posts 122, which surfaces are aligned vertically and parallel to the conveying direction 144, and hence guarantee guidance of the conveying carriage 138 transversely of the longitudinal direction 144 thereof.

Disposed between the transverse guide rollers 160, on each of the outer vertical struts 146 of the guide framework 136, there are in each case two longitudinal guide rollers 164, which are rotatable about horizontal axes of rotation directed at right angles to the longitudinal direction 144 of the conveying carriage 138. As the conveying carriage 138 moves up and down, these longitudinal guide rollers 164 roll along longitudinal guide surfaces 166 of the posts 122, which surfaces are aligned vertically and at right angles to the longitudinal direction 144, and hence guarantee guidance of the conveying carriage 138 in longitudinal direction 144 thereof.

As may best be seen from FIGS. 14 and 15, on the guide framework 136 a retaining device 168 of the conveying carriage 138 is disposed, which comprises a longitudinal beam 170, which extends parallel to the longitudinal direction 144 of the conveying carriage 138 and is fastened to the outer vertical struts 146 below the bottom longitudinal strut 140 of the guide framework 136 and from each end of which an extension arm 172 projects in a horizontal transverse direction 174 extending at right angles to the longitudinal direction 144.

Disposed on each extension arm 172 is a rotary drive motor 176 which, in each case via a gear unit 178 and two drive shafts 180 extending along the transverse direction 174, may set two retaining elements 182 fastened rigidly to the drive shafts 180 in swivelling motion about the axis of rotation 181 of the respective drive shaft 180.

As may best be seen from FIG. 15 as well as 4 and 6, each retaining element 182 comprises two swivel arms 184, which are mutually spaced apart along the respective swivelling axis 181 and are fastened in each case at one end to one of the drive shafts 180 and connected to one another by a web 186 in each case at their free end remote from the drive shaft 180. Fastened by means of fastening screws 188 to the web 186 of each retaining element 182 there is in each case a substantially cuboidal carrying plate 190.

The retaining elements 182 are pivotable by means of the respective associated rotary drive motor 176 from the inoperative position shown for example in FIG. 4, in which a carrying surface 192 of the carrying plate 190 remote from the web 186 is aligned substantially vertically, into the operating position shown for example in FIG. 6, in which the carrying surface 192 of the carrying plate 190 is aligned substantially horizontally.

Each retaining element is moreover pivotable by means of the associated rotary drive motor 176 from the operating position back into the inoperative position.

As may best be seen from FIGS. 1 to 3, the conveying apparatus 118 further comprises a stationary roller conveyor 194, which is disposed on the first conveying level 106 and which (see in particular FIG. 3) comprises a rectangular structural framework 196, which is supported via support feet 198 on the subsurface.

Mounted in the structural framework 196 is a plurality of, e.g. four, support rollers 200, which are rotatable about horizontal axes of rotation aligned parallel to the conveying direction 174 of the conveying carriage 138.

The support rollers 200 are mutually spaced apart along the longitudinal direction 144 of the conveying carriage 138.

The stationary roller conveyor 194 further comprises a drive motor 202, which via toothed belts 204 and pinions disposed on the support rollers 200 may set the support rollers 200 adjacent to the drive motor 202 in rotation about their respective axis of rotation, while the support rollers 200 disposed further away from the drive motor 202 are driven indirectly by the directly driven support rollers 200 via further pinions and further toothed belts 204.

When a vehicle body 102 disposed on a skid frame 104 is situated on the stationary roller conveyor 194, the skid runners 206 aligned parallel to the longitudinal direction of the vehicle body 102 are supported by the crests of the support rollers 200 of the stationary roller conveyor 194.

The skid runners 206 of the skid frame 104, which are aligned parallel to one another, are connected to one another by crossbeams 208, on which securing devices 210 are provided for detachably fastening the vehicle body 102 to the skid frame 104.

As may best be seen from FIGS. 3 and 5, the stationary roller conveyor 194 along the longitudinal direction 144 is designed shorter than the skid runners 206 of the skid frame 104, so that the skid frame 104 disposed on the stationary roller conveyor 194 projects by the front and back end regions 212 of its skid runners 206 beyond the structural framework 196 of the roller conveyor 194.

The skid frame 104 is designed shorter than the spacing D between the carrying surfaces 192 of the front retaining elements 182a and the carrying surfaces 192 of the rear retaining elements 182b in the inoperative position of the retaining elements that is illustrated in FIGS. 3 and 4.

The conveying carriage 138 with the retaining device 168 disposed thereon may therefore be moved in vertical direction past the skid frame 104 when the retaining elements 182 of the retaining device 168 are situated in the inoperative position.

However, when the retaining elements 182 are pivoted into the operating position illustrated in FIGS. 5 and 6, the front retaining elements 182a and the rear retaining elements 182b have a mutual spacing D′, which is smaller than the longitudinal extension of the skid runners 206.

In this operating position of the retaining elements 182, the carrying surfaces 192 lie against the undersides of the end regions 212 of the skid runners 206, so that the skid frame 104 is carried by the carrying plates 190 of the retaining device 168.

For this purpose, the front retaining elements 182a are mutually offset along the transverse direction 174 by a spacing d (see FIG. 15), which corresponds to the spacing, by which the skid runners 206 of the skid frame 104 are mutually offset in the transverse direction.

The roller conveyors 110 disposed upstream of the conveying apparatus 118 on the first conveying level 106 are of fundamentally the same construction as the stationary roller conveyor 194 but may be designed longer than the skid runners 206 of the skid frames 204.

Between the stationary roller conveyor 194 of the conveying apparatus 118 and the last of the roller conveyors 110 disposed upstream of the conveying apparatus 118 on the first conveying level 106 a gap 214 is provided, the extent of which along the first conveying direction 108 is large enough to allow an extension arm 172 of the retaining device 168 with the rotary drive motor 176 disposed thereon and with retaining elements 182 situated in the operating position to pass between the stationary roller conveyor 194 and the roller conveyor 110 lying upstream thereof in the first conveying direction 108.

As may best be seen from FIGS. 8 to 12, the conveying apparatus 118 further comprises a roller conveyor 216, which is disposed on the second conveying level 112 and is of a substantially identical construction to the stationary roller conveyor 194 on the first conveying level 106 but is displaceable by means of a telescopic unit 218 from a delivery position, in which the movable roller conveyor 216 is aligned with the roller conveyors 116 disposed in the second conveying direction 114 downstream of the conveying apparatus 118 on the second conveying level 112, into an acceptance position, in which the movable roller conveyor 216 is disposed vertically above the stationary roller conveyor 194.

The displacement from the delivery position to the acceptance position and back again is effected parallel to the transverse direction 174 of the conveying carriage 138, so that the first conveying direction 108 on the first conveying level 106 and the second conveying direction 114 on the second conveying level 112 are mutually offset in this transverse direction 174 (see FIG. 11).

The telescopic unit 218 illustrated in particular in FIG. 13 comprises two telescopic drive units 219, which are mutually spaced apart in longitudinal direction of the telescopic unit 218 and each of which comprises a bottom part 220 disposed in a stationary manner on the second conveying level 112, a middle part 222 guided displaceably in the transverse direction 174 on the bottom part 220, and a top part 224 guided displaceably in the transverse direction 174 on the middle part 222 and carrying the movable roller conveyor 216.

Disposed on the telescopic unit 218 is a geared motor 221, which via articulated shafts 223 (or, alternatively thereto, a transmission) sets in rotation in each case an input gear wheel 226, which is disposed rotatably on each of the bottom parts 220 and in turn drives a series of large gear wheels 228 and small gear wheels 230 disposed successively along the transverse direction 174 (see the purely diagrammatic view of FIG. 13).

The rotational movement of the large gear wheels 228 is converted by means of a toothed rack 232 fastened to the middle part 222 into a translational movement of the middle part 222 relative to the bottom part 220 along the transverse direction 174. When the middle part 222 is moved in FIG. 13 to the right, this translational movement is transmitted by means of a first transmission unit 234 to the top part 224.

The first transmission unit 234 comprises a chain 236, which is fastened at a first fastening point 236 to the bottom part 220 and at a second fastening point 238 to the top part 224 and between these fastening points runs by way of a return chain wheel 240, which is disposed rotatably on the middle part 222 at a point situated to the right of the second fastening point 238.

When this return chain wheel 240 moves together with the middle part 222 to the right, the top part 224 is also moved to the right owing to the shortening of the chain portion above the return chain wheel 240.

For retraction of the telescopic drive units 219, the input gear wheels 126 on the bottom parts 220 are set in the opposite direction of rotation, so that the associated middle part 222 moves in FIG. 13 to the left.

This translational movement of the middle part 222 is transmitted by means of a second transmission unit 242 to the top part 224.

The second transmission unit 242 comprises a chain 244, which is fastened at a first fastening point 246 to the bottom part 220 and at a second fastening point 248 to the top part 224 and between these fastening points runs by way of a return chain wheel 250, which is disposed rotatably on the middle part 222 at a point situated to the left of the second fastening point 248.

When this return chain wheel 250 is moved with the middle part 222 to the left, the top part 224 is likewise moved to the left owing to the reduction of the chain portion above the return chain wheel 250.

The movable roller conveyor 216 disposed on the top parts 224 of the telescopic drive units 219 corresponds in its dimensions to the stationary roller conveyor 194.

In particular, the structural framework 196 of the movable roller conveyor 216 in longitudinal direction 144 is designed shorter than the skid runners 206 of the skid frames 204.

The structural framework 196 of the movable roller conveyor 216 is moreover designed shorter than the spacing D′ between the front retaining elements 182a and the rear retaining elements 182b in the operating position of the retaining elements.

The presently described conveying system operates as follows.

By means of the roller conveyors 110 on the first conveying level 106 vehicle bodies 102 disposed on skid frames 104 are fed to the conveying apparatus 118.

When a first vehicle body 102a is situated on the stationary roller conveyor 194 of the conveying apparatus 118 (first position of the vehicle body), the conveying carriage 138 is moved by means of the drive unit 126, with the retaining elements situated in the inoperative position, down into the position shown in FIG. 3, in which the retaining elements 182 of the retaining device 168 are situated below the skid runners 206 (first location of the conveying carriage).

In said case, the retaining elements 182 are moved past the skid runners 206, this being easily possible because the spacing D between the carrying surfaces 192 of the retaining elements 182 in the inoperative position exceeds the length of the skid runners 206.

The retaining elements 182 are then brought by means of the rotary drive motors 176 into the operating position illustrated in FIGS. 5 and 6, in which the end regions 212 of the skid runners 206 rest in each case on a carrying plate 190 of a retaining element 182.

The conveying carriage 138 with the vehicle body 102 carried by the retaining device 168 is then displaced in vertical direction from its lower first location into its upper final location (see FIG. 7). At the same time, a second vehicle body 102b is already being conveyed onto the stationary roller conveyor 194 of the conveying apparatus 118 (see FIG. 7).

Once the conveying carriage 138 has arrived in its upper final location (second location of the conveying carriage), the vehicle body 102a is situated in its second position on the second conveying level. The movable roller conveyor 216 is then moved by means of the telescopic unit 218 along the transverse direction 174 into the region below the skid frame 104 of the first vehicle body 102a and between the extension arms 172 of the retaining device 168 (see FIG. 8).

As soon as the telescopic drive units 219 are fully extended and the movable roller conveyor 216 is situated directly below the skid frame 104 of the first vehicle body 102a, the conveying carriage 138 is moved back down from the second location, wherein the skid runners 206 are deposited on the support rollers 200 of the movable roller conveyor 216 (see FIG. 9), so that the conveying carriage 138 moves further downwards in an empty state.

The movable roller conveyor 216 with the first vehicle body 102a disposed thereon is then moved from the acceptance position into the delivery position, in which the movable roller conveyor 216 is aligned with the next roller conveyor 116 on the second conveying level 112. At the same time, the conveying carriage 138 is moved back down into the first location.

During the downward movement of the conveying carriage 138, the retaining elements 182 of the retaining device 168 are swivelled by means of the rotary drive motors 176 from the operating position back into the inoperative position in order to allow the retaining device 168 to move past the skid frame 104 of the second vehicle body 102b, which is already waiting in the first position on the stationary roller conveyor 194 (FIG. 10).

As soon as the conveying carriage 138 has arrived in its lower final position (first location), the retaining elements 182 are swivelled by means of the rotary drive motors 176 from the inoperative position back into the operating position, in which the end regions 212 of the skid frame 104 of the second vehicle body 102b rest on the carrying surfaces 192 of the retaining elements 182. The second vehicle body 102b is then lifted from the first position into the second position on the second conveying level 112 in the manner already described above in connection with the first vehicle body 102a.

While the second vehicle body 102b is being conveyed in an upward direction, the first vehicle body 102a is conveyed by the movable roller conveyor 216, which is situated in the delivery position, along the second conveying direction 114 onto the adjoining roller conveyor 116 on the second conveying level 112 so that the movable roller conveyor 216 is available once more for acceptance of the second vehicle body 102b.

At the same time, the third vehicle body 102c following behind the second vehicle body 102b is already being conveyed by the roller conveyor 110 disposed upstream of the conveying apparatus 118 on the first conveying level 106 onto the stationary roller conveyor 194 of the conveying apparatus 118.

Because in each case the next vehicle body 102 is already conveyable into the waiting position on the stationary roller conveyor 194 while the conveying carriage 138 with the preceding vehicle body 102 is still situated outside of the lower final location, the cycle time of the conveying apparatus 118 that is needed for the conveying operation from the first conveying level 106 to the second conveying level 112 may be shortened by, for example, approximately five seconds.

The previously described conveying apparatus 118 may also be used to lower vehicle bodies 102 from the upper conveying level 112 to the lower conveying level 106. For this, it is merely necessary to reverse the throughfeed direction of the vehicle bodies 102 and carry out the previously described sequences in reverse order.

Preferably, in the event of a reversal of the throughfeed direction of the vehicle bodies 102, the vehicle bodies 102 themselves are also rotated through 180° so that the front part of the vehicle body 102 with the engine bonnet is pointing in the respective conveying direction.

1. Conveying apparatus for conveying a workpiece, in particular a vehicle body, disposed on a workpiece support, from a first position on a first conveying level to a second position on a second conveying level, comprising a conveying carriage, which is movable from a first location associated with the first position of the workpiece to a second location associated with the second position of the workpiece and from the second location to the first location, wherein the conveying carriage comprises a retaining device having at least one retaining element, which is movable relative to the conveying carriage from an operating position, in which the retaining element may act on the workpiece support, into an inoperative position, in which the retaining element is movable past the workpiece support, and from the inoperative position into the operating position.

2. Conveying apparatus according to claim 1, wherein the retaining element is pivotable from the operating position into the inoperative position.

3. Conveying apparatus according to claim 2, wherein the retaining element is pivotable about a substantially horizontal swivelling axis.

4. Conveying apparatus according to claim 1, wherein the retaining element is movable by means of a motor, which is disposed on the conveying carriage, in particular on the retaining device, from the operating position into the inoperative position and/or from the inoperative position into the operating position.

5. Conveying apparatus according to claim 1, wherein the retaining device comprises at least two retaining elements, which are mutually spaced apart in a longitudinal direction of the retaining device.

6. Conveying apparatus according to claim 5, wherein the spacing of the two retaining elements along the longitudinal direction of the retaining device in the inoperative position of the retaining elements is larger than the extent of the workpiece support in the longitudinal direction of the retaining device.

7. Conveying apparatus according to claim 1, wherein the retaining device comprises at least two retaining elements, which are mutually spaced apart transversely of a longitudinal direction of the retaining device.

8. Conveying apparatus according to claim 7, wherein the workpiece to be conveyed is disposed on a skid frame and the two retaining elements are mutually offset transversely of the longitudinal direction of the retaining device by substantially the same distance, by which the skid runners of the skid frame are mutually offset transversely of the longitudinal direction of the retaining device.

9. Conveying apparatus according to claim 1, wherein the retaining element comprises a carrying plate for carrying a region of the workpiece support.

10. Conveying apparatus according to claim 1, wherein the conveying apparatus comprises an acceptance platform, by which the workpiece in the first position is accepted from the retaining device of the conveying carriage.

11. Conveying apparatus according to claim 10, wherein the acceptance platform is disposed in a stationary manner.

12. Conveying apparatus according to claim 10, wherein the acceptance platform is movable relative to the first position of the workpiece.

13. Conveying apparatus according to claim 12, wherein the acceptance platform is movable, in particular displaceable, transversely of a conveying direction, along which the workpiece is conveyed on the first conveying level to the conveying apparatus.

14. Conveying apparatus according to claim 12, wherein the acceptance platform is movable by means of a telescopic drive.

15. Conveying apparatus according to claim 10, wherein the acceptance platform takes the form of a roller conveyor.

16. Conveying apparatus according to claim 10, wherein the retaining device comprises two retaining elements, which are mutually spaced apart along a longitudinal direction of the retaining device, and the extent of the acceptance platform along the longitudinal direction of the retaining device is smaller than the spacing of the two retaining elements along the longitudinal direction of the retaining device in the inoperative position and/or in the operating position of the retaining elements.

17. Conveying apparatus according to claim 1, wherein the conveying apparatus comprises a transfer platform, to which the workpiece in the second position is transferred from the retaining device of the conveying carriage.

18. Conveying apparatus according to claim 17, wherein the transfer platform is disposed in a stationary manner.

19. Conveying apparatus according to claim 17, wherein the transfer platform is movable relative to the second position of the workpiece.

20. Conveying apparatus according to claim 19, wherein the transfer platform is movable, in particular displaceable, transversely of a conveying direction, along which the workpiece is conveyed further on the second conveying level.

21. Conveying apparatus according to claim 19, wherein the transfer platform is movable by means of a telescopic drive.

22. Conveying apparatus according to claim 17, wherein the transfer platform takes the form of a roller conveyor.

23. Conveying apparatus according to claim 17, wherein the retaining device comprises two retaining elements, which are mutually spaced apart along a longitudinal direction of the retaining device, and the extent of the transfer platform along the longitudinal direction of the retaining device is smaller than the spacing of the two retaining elements along the longitudinal direction of the retaining device in the inoperative position and/or in the operating position of the retaining elements.

24. Conveying apparatus according to claim 1, wherein a workpiece is bringable into the first position while the conveying carriage is situated outside of the first location.

25. Conveying apparatus according to claim 1, wherein a workpiece is bringable into the first position while another workpiece is disposed on the retaining device of the conveying carriage.

26. Conveying system, comprising a conveying apparatus according to claim 1 and at least one conveying device, which feeds the workpiece to the conveying apparatus on the first conveying level.

27. Conveying system according to claim 26, wherein the conveying device comprises at least one roller conveyor.

28. Conveying system, comprising a conveying apparatus according to claim 1 and at least one conveying device, which accepts the workpiece from the conveying apparatus on the second conveying level.

29. Conveying system according to claim 28, wherein the conveying device comprises at least one roller conveyor.

30. Method of conveying a workpiece, in particular a vehicle body, disposed on a workpiece support, from a first position on a first conveying level to a second position on a second conveying level by means of a conveying carriage, which is moved from a first location associated with the first position of the workpiece to a second location associated with the second position of the workpiece and from the second location to the first location, wherein at least one retaining element of a retaining device of the conveying carriage is moved relative to the conveying carriage from an operating position into an inoperative position, is moved in the inoperative position past the workpiece support, then is moved from the inoperative position into the operating position and in the operating position acts on the workpiece support.

31. Method according to claim 30, wherein the retaining element is pivoted from the operating position into the inoperative position.

32. Method according to claim 31, wherein the retaining element is pivoted about a substantially horizontal swivelling axis.

33. Method according to claim 30, wherein the retaining element is moved from the operating position into the inoperative position by means of a motor, which is disposed on the conveying carriage, in particular on the retaining device.

34. Method according to claim 30, wherein the retaining device of the conveying carriage accepts the workpiece in the first position from an acceptance platform.

35. Method according to claim 34, wherein the acceptance platform is moved into the first position prior to acceptance of the workpiece by the retaining device.

36. Method according to claim 35, wherein the acceptance platform is moved, in particular displaced, transversely of a conveying direction, along which the workpiece has been conveyed on the first conveying level to the conveying apparatus.

37. Method according to claim 35, wherein the acceptance platform is moved by means of a telescopic drive.

38. Method according to claim 30, wherein the workpiece in the second position is transferred from the retaining device of the conveying carriage to a transfer platform.

39. Method according to claim 38, wherein the transfer platform is moved together with the workpiece from the second position.

40. Method according to claim 39, wherein the transfer platform is moved, in particular displaced, transversely of a conveying direction, along which the workpiece is conveyed further on the second conveying level.

41. Method according to claim 39, wherein the transfer platform is moved by means of a telescopic drive.

42. Method according to claim 30, wherein a workpiece is brought into the first position while the conveying carriage is situated outside of the first location.

43. Method according to claim 30, wherein a workpiece is brought into the first position while a further workpiece is disposed on the retaining device of the conveying carriage.
